(19) United States
(12) Patent Application Publication
(10) Pub. No.: US 2010/0183878 A1
(43) Pub. Date: Jul. 22, 2010

(54) Coated Discrete Particle, Method For Preparation Thereof, And Product In Which This Particle Is Applied

(75) Inventors: Herman Reezigt, Ootmarsum (NL); Bartholomeus Wihelmus Maria Rouwers, Ootmarsum (NL); Hendrik Glastra, Enschede (NL); Johannes Wilhelmus Otto Salari, Eindhoven (NL)

Correspondence Address: TROUTMAN SANDERS LLP;5200 BANK OF AMERICA PLAZA, 600 PEACHTREE STREET, N.E., SUITE 5200, ATLANTA, GA, 30308-2216, US

(73) Assignee: Capzo International B.V., Ootmarsum (NL)

(21) Appl. No.: 12/663,694

(22) PCT Filed: Jun. 9, 2008
(86) PCT No.: PCT/NL08/00147

§ 371 Date: Dec. 8, 2009

(30) Foreign Application Priority Data
Jun. 8, 2007 (BE) 2007/0289

(51) Int. Cl. B32B 1/00; B05D 7/00

(52) U.S. Cl. 428/407; 428/403; 427/212

(57) ABSTRACT

The invention provides a coated particle, as well as a method for the preparation thereof and a material or object in which such a particle is applied. The particle consists of a core material and a coating layer. The core material is a homogeneous composition of a salt hydrate and an additive chemical. The salt hydrate provides to the particle its specific technical properties and the additive chemical is chemically bound to the coating layer. The composition of the coating layer is, dependent on the application, mainly determined by the applications and the raw chemicals used.

There is a demand for encapsulated salt hydrates in general and encapsulated phase change materials (PCM) more specific, i.e., for particles consisting of a core containing the salt hydrate, which is surrounded by a protective coating layer. Such particles have useful applications, as known from U.S. Pat. No. 4,513,053, U.S. Pat. No. 5,709,945 and DE-10218977.

The particles contain a salt hydrate that gives the particles their functional properties, such as heat storage. The particles, which can have dimensions varying between roughly 1 to 10,000 μm, can be incorporated into applicable products, e.g. raw materials for construction/building purposes, clothing, etc. The protective coating layer has the function of protecting the functional core against influences from the outside environment. Furthermore, the function of the protective coating layer is to prevent the outward diffusion of water from the salt hydrate, which can occur after the phase transition of the salt hydrate.

U.S. Pat. No. 5,709,945 describes a spherical capsule based on salt hydrates that have been encapsulated using different layers of coating material consisting of a hydrophobic wax and polymer material. This coating material is applied using a physical spray process and the coating material is physically attached onto the salt hydrate. This type of attachment is rather weak, which leads to an insufficient protection. Moreover, the used technology for preparation of such multiple-layered capsules is complicated, time-consuming and expensive.

U.S. Pat. No. 4,513,053 also describes a physical spray process for preparation of the particles.

DE-10218977 describes a salt hydrate-which might be encapsulated and of which the surface is modified with at least one layer, in order to accomplish the minimization of phase differences at both sides of the phase boundary between salt hydrate possessing the modificating layer and the surrounding medium in which the salt hydrate possessing the modificating layer is being applied.

Which type of encapsulation material is used for this purpose and which technique is used to apply the coating material onto the salt hydrate surface is not described herein. The modificating layer has no application for protection and/or prevention of the water diffusion. For application of the modificating layer non-conventional and thus enxpensive raw materials are necessary and the preparation process is complicated and time-consuming. The type of chemistry of e.g. silanes requires that reaction conditions, such as humidity, temperature and acidity are being controlled very carefully, the exact conditions being very critical.

WO-2005/097935 describes a polymer composition containing a salt hydrate. The publication mentions that a protective layer might be applied, but does not give any details concerning the protective material and the method for applying this layer.

It is a general aim of the present invention to cancel out or at least to minimize the mentioned drawbacks.

More specific, the present invention aims on supplying the respective particles, with enhanced properties of the protective layer, especially regarding the long-term stability.

Furthermore, the present invention aims on supplying the respective particles that can be prepared using a relatively simple and cheap method, in which reaction condition are not so critical.

Furthermore, the present invention aims on supplying a relatively simple and cheap method for preparation of particles consisting of salt hydrate core, surrounded by a protective coating layer with long-term stability

According to the present invention, the core of a particle consists of a homogeneous composition that contains at least one salt hydrate and one additive chemical, and the core is surrounded by a protective coating layer that is chemically bound to the additive chemical.

Thus, the invention is based on breaking with the traditional idea that the protective layer should be bonded to the salt hydrate and on the inventive idea of adding an additive chemical that, on one hand, forms a stable combination with the salt hydrate and, on the other hand, forms a basis on which the protective coating layer can attach with a long-term stability. Herewith the problem that it is difficult to well-attach a suitable protective coating layer to the salt hydrate is being overcome and the advantage is offered to be able to search for an adequate combination of salt hydrate and additive chemical, dependent on the salt hydrate or mixture of salt hydrates that is being used, as well as a coating layer material that attaches to the additive chemical. All this can be achieved in such a way that the methods for addition of the additive chemical to the salt hydrate and for attaching the protective coating layer material to the additive chemical are relatively simple methods, using simple materials, and are relatively cheap methods as well.

According to one aspect of the present invention, at least one salt hydrate and one additive chemical are used to constitute the homogeneous composition for providing the particle core.

With respect to the present invention, with “composition” is meant: a composite or mixture. Preferentially, the one salt hydrate and one additive chemical are used to create a eutectic mixture.

With respect to the present invention, with “homogeneous” is meant that the fractions of the particle core, on a sufficiently long length scale, that is considerably smaller that the dimensions of the particle core, have the same nature, composition and properties.

For example, a particle core has a homogeneous composition when it consists of a mixture of which the constituting components are distributed over the interior of the core as equally as possible and their presence at the surface of the core is as equally as possible, too. One and other is, however, dependent on the nature and dimensions of the constituting components, which is evident to the experts. An equal distribution of the components can be achieved, for example, when the components are present as particles that have dimensions which are several orders of magnitude smaller than the dimensions of the particle core. However, it is possible, and even preferential, that the additive consists of a polymer, having chain lengths the same order of magnitude as the particle core dimensions. In an extreme case, the additive has the form of a large clew of polymer, with the clew being spatially distributed over the entire particle core and with salt hydrate being present both within the clew as well as around it: also this type of configuration is regarded to be a homogeneous composition with respect to the present invention.

The additive chemical is prefentially a polar or hydrophilic compound with at least one chemically reactive group. More preferentially, the additive is a polymer compound or a non-polymer organic compounds. A mixture of different additive chemicals might be present. An additive chemical might posses more than one reactive group, in which case the different reactive groups can be the same or different. Suitable reactive groups are, e.g., amino, hydroxyl, carboxyl or carboxylate groups.

The coating layer preferentially consists of at least one polymer or polymeric compound with at least one chemically reactive group. The coating layer can essentially cover the core entirely, to fully enclose the core material. It is, however, also possible that it is desired that the coating layer only partially covers the core material, or that the coating layer is porous or at least partially permeable for certain chemical compounds, e.g. water, offering the possibility of a controlled exchange of material from the core to the surrounding environment or vice versa. By controlling the chemical process parameter during the coating procedure it is possible to predetermine coating parameters such as composition and thickness. This way, the permeability is prearranged. Furthermore, it is also possible that the coating layer consists of different polymer layers having reactive groups. These layers can be connected to each other.

The chemical(s) that are used as additive chemical and coating layer material, respectively, are selected depending on the application of the particle and with respect to the salt hydrate that is used. The selection is made such that a reactive group from the coating layer material forms a chemical bond with a reactive group from the additive chemical. Obviously, this chemical bond will be established predominantly between reactive groups that are present at the surface of the core.

As already mentioned, the salt hydrate that is used gives the particle a certain advantageous functional properties. In a particular useful example, the salt hydrate is a heat-accumulating phase change material and the particles are suitable for heat storage. The additive chemical(s) are chosen with respect to the salt hydrate and are preferentially chosen as such that the advantageous functional properties (like heat storage) are maintained fully or at least to an acceptable level.

Thus, the additive chemical and the salt hydrate form an uncoated, stable composition that displays a technical action or effect, owing to the salt hydrate, e.g., a heat-accumulation effect and that can form a bond with the coating material owing to the additive chemical. In special cases, the additive chemical might even enhance the properties of the salt hydrates because, e.g., the salt hydrates are being incorporated into the structure of the additive chemical. In this case, the additive chemical has a dual function.

The coating serves for maintaining the composition of the core material constant and/or protecting it. The protective action of the coating layer is very long-lasting because the coating layer material is chemically bound to the core, i.e., to the present additive chemical. In a preferential example, the coating layer material is chemically bound to a salt hydrate inside the core as well.

According to the invention, the particles can be used in construction materials, like concrete and bricks, and in heat-resistant construction materials and isolation materials, or for example in textile and clothing, like thermopaks. The core material that is being used is chosen with respect to the intended application of the particles, which is evident to the experts; e.g., in the case of a heat-accumulating phase change material, the intended operational temperature will play a role. Depending on the intended applications of the particles according to the invention, the properties of the coating layer material will be chosen and/or preset, like composition, amount of layers, thickness, compactness and porosity. This way the particles according to the invention can be suitable for extreme conditions: e.g., textile for use at high temperatures. In this example of an application, the coating layer should be able to withstand high temperatures.

Furthermore, it is preferential that a thickening agent is present in the core and/or coating layer material to limit phase separation and/or a nucleating agent (seed crystal) to prevent subcooling. The core and/or coating layer material can contain more additive chemicals.

Preferential examples of the discrete particles according to the invention are described in conclusions 2 to 21.

Hereafter, the core and coating layer materials according to the invention are being elaborated further.

The particle core can contain salt hydrates of one type, but also a mixture of different salt hydrates. Examples of suitable salt hydrates are compound that can be heat-accumulating phase change materials, like sodium acetate trihydrate, calcium chloride hexahydrate or sodium sulfate decahydrate (Glauber's salt).

As additive chemicals can be used: e.g., linear or branched polymers, copolymers, block polymers, cross-linked polymers and/or mixtures of different polymers. Examples include polyacrylates and more specifically poly(acrylic acid), poly(acrylic amide) or copolymers of acrylic acid and acrylic amide. The use of polyacrylate, polyol, polyepoxy and/or polysulfide has turned out to be exceptionally suitable as additive chemical for (in)organic salt hydrates, because these additive chemical form a chemical bond with the salt hydrate and thus results in a composite material that is stable and solid at temperatures above the phase transition temperature. It is being remarked that, according to the example, it is possible that the salt hydrate is bound to another chemical group of the additive chemical than the reactive group that binds to the coating layer material. Other alternatives for an additive chemical are non-polymer organic compounds containing the abovementioned reactive groups, like amines, amides and/or amino-acids. Examples include: formamide, urea, acetamide, glycine and alanine. This type of additive chemical forms, according to the invention, eutectic mixture with the salt hydrates, e.g., sodium acetate trihydrate with urea or acetamide. A core material that is solid at room temperature and consists of a homogeneous mixture of a inorganic salt hydrate and a small organic compound forms a special type of eutectic compound which has a lower melting point that the individual constituting components. This, in turn, offers advantages.

It was already mentioned that, according to the invention, the coating layer preferentially consists of at least one polymer or polymer compound containing at least one chemically reactive group. The polymer can be a copolymer or block polymer, but it is also possible that a mixture of different polymers is used. The polymer can contain both polar and non-polar residues or units, when required branched. A non-polar residue gives the polymer its hydrophobic character. The reactive groups can be all kinds of well-known chemical groups, like anhydride or isocyanate groups, that form ester or amide bonds with the reactive groups of the additive chemical. The polymer chains containing the reactive groups can be interconnected using cross-linking agents, such as di- or trifunctional amines with which a polymer network can be established.

The reactive polymers of the coating layer material consist preferentially of maleic anhydride (MAH) residues. These can be copolymers or graft-polymers of MAH or MAH derivatives on one hand and of non-MAH monomers on the other hand. Typical examples of copolymers containing MAH are poly(styrene-co-maleic anhydride), poly(maleic anhydride-alt-1-octadecene), poly(ethylene-alt-maleic anhydride), poly(propylene-alt-maleic anhydride), poly(isobutylene-alt-maleic anhydride), poly(styrene-alt-maleic anhydride) and derivative thereof. Typical examples of graft-polymers containing MAH are poly(ethylene-graft-maleic anhydride), poly(isoprene-graft-maleic anhydride), poly(propylene-graft-maleic anhydride) and derivatives thereof.

The main advantage of polymers containing MAH residues is their functionality and availability. The combination of both non-polar monomers and the polar monomer (MAH) makes the polymer soluble is various solvents, like acetone, ethyl acetate and toluene that can be used during the encapsulation of the core material according to the invention. The anhydride functionality is very reactive towards amidation, esterification and hydrolysis. The MAH functionality is necessary for binding of the polymer with the particle. The non-polar part of the polymer gives the particle a surface that is rendered inert. Therefore, this combination is very suitable. An additional advantage is that such polymers are commercially available.

The present invention provides both a relatively simple and cheap method for preparation of the mentioned particles. First, the particle core is prepared using a composition containing at least one salt hydrate and at least one additive chemical. Second, a coating layer is applied around the particle core. During this process, a chemical bond between additive chemical and coating layer material is formed. In a possible example, the composition is being prepared as a solid material that is being cut into smaller pieces, e.g. by milling.

Preferential examples of the preparation methods according to the invention are described in conclusions 23 to 32.

In a specific example, the core material according to the invention is being dispersed in an organic liquid and is subsequently treated with a solution in which is dissolved or dispersed a compound containing at least one chemically reactive group which is able to form a coating layer, or dispersed in an organic solution of a compound which is able to form a coating layer. This way, the core material is coated via a simple method and the thus obtained coated core material is a stable and long-lasting product having various possible applications. The coating layer material is preferentially a polymer compound. The coating layer material can also be added to the dispersed core material as a solid material or dispersion, in which case it dissolves in the dispersion liquid of the core particles.

According to the invention the encapsulation of core material containing a salt hydrate is being promoted by a reactive group at the surface of the core that can react with a reactive group of the coating layer material (polymer), like MAH. This reactive group is preferentially an amino group of a primary amine (—NH2). Hydroxyl groups (—OH) and carboxyl (—COOH) or carboxylate groups are suitable for this purpose as well, but require more extreme conditions to accomplish a reaction with MAH polymers. Furthermore it is preferable that the core material is in a solid state during this treatment with the polymer, e.g., as a dispersion.

The present invention provides in particular two methods for introducing chemical functionality onto the surface of the core. The first method uses e.g. super-absorbing polymers (SAP) as additive chemicals according to the invention that are capable of binding or absorbing the salt hydrates. Typical polymers which can be used for this purpose are mainly polyacrylates. The super-absorbing action of these polymers is mainly attributed to the presence of amino, hydroxyl and/or carboxyl/carboxylate functionalities. These groups are also suitable for the reaction with e.g. MAH polymers for the eventual encapsulation.

Typical examples of monomers that can be used as precursors for making polymer particles with salt hydrate as homogeneous core material are: acrylate monomers, like (meth)acryl amide, (meth)acrylic acid, epoxy(meth)acrylate, hydroxyethyl (meth)acrylate, (meth)acrylate salts, methylene bis(meth)acryl amide, as well as the salts and derivatives thereof. The polymerization of one or more monomers result is polymers that swell in water, that can absorb and retain hydrophilic liquids. This property is being used to obtain stable compositions with salt hydrates. If required, a cross-linking agent such as methylene bisacryl amide is used during the polymerization, resulting in a homogeneous core material containing the salt hydrates which are, according to the invention, absorbed or bound in a network of the additive chemical. The latent chemical functionality of the aforementioned monomers that are used for encapsulation are mainly amino groups of primary amines (—NH2), hydroxyl groups (—OH) and carboxyl (—COOH) or carboxylate groups.

The second method to introduce chemical functionality onto the surface of the core uses a non-polymeric organic compound with the respective chemical functionality as additive chemical according to the invention, which is mixed with the salt hydrates according to the invention. Typical compounds that can be used for this purpose are formamide, urea, acetamide, glycine and alanine.

For the uptake of salt hydrates in a super-absorbing polymer, the present invention provides two methods. In the first method, the salt hydrate is being heated above the phase transition temperature, so that a clear liquid is obtained, which is subsequently mixed with one or more of the abovementioned monomers and possibly a cross-linking agent. Subsequently, the whole is polymerized using an initiator and this way the salt hydrates are being taken up or bound in the resulting super-absorbing polymer. In the second method, the salt hydrate is also molten to above the phase transition temperature and then simply mixed with an existing super-absorbing polymer.

For optimization of e.g. the thermal properties of the salt hydrates according to the invention a nucleating agent (seed crystal) is added to a reaction mixture of salt hydrates and monomers. The choice of nucleating agent is being determined by the type of salt hydrate and additive chemical. Herewith the sub-cooling of the respective core material decreases in favor of the stability of the homogeneous core material and, therewith, also that of the respective discrete particle according to the invention.

Suitable nucleating agents (seed crystals) for a core material based on sodium acetate trihydrate and polyacrylate are: sodium phosphate, sodium pyrophosphate decahydrate, sodium carbonate and potassium sulfate. Other suitable additives are strontium chloride hexahydrate as nucleating agent and graphite for improving heat transfer, pigment for obtaining a specific colour.

The use of a polymer for obtaining a stable composition with the inorganic salt hydrate offers the possibility of making a powder (i.e., being microparticles). First, the composition can be prepared as a bulk which is subsequently milled, and if required, sieved. An other option is to carry out a so-called dispersion/suspension polymerization. Here, the same reaction mixture as for bulk production is being dispersed into an organic liquid and subsequently the polymerization is initialized. This way the microparticles are directly obtained as a dispersed phase in the organic solvent. The microparticles can be used for encapsulation immediately, without the necessity for milling.

In an example of the method, proposed in the present invention, for encapsulation of the particle cores with the salt hydrates according to the invention, these are dispersed in the organic solvent according to the invention. The liquid should not be too polar because the particle cores will be dissolved. Water, for example, is less suitable. The liquid should also not be too non-polar because in this case the reactive polymer, used for encapsulation, does not dissolve in it. For example, paraffin is less suitable for this because co- and graft-polymers with MAH do not dissolve in it. Typical examples of suitable liquids are: ethanol, acetone, isopropanol and toluene or a mixture of two or more of the abovementioned liquids. Furthermore, these solvents are quite common and, therefore, relatively cheap starting materials. A typical amount of particles containing salt hydrates that are being dispersed in the liquid is preferentially 5 to 50% by weight with respect to the liquid. The dispersion is stirred vigorously otherwise the particles containing the salt hydrates will precipitate and it will be impossible to encapsulate them efficiently. Subsequently a certain amount of the MAH polymer is dissolved in e.g. acetone and added to the dispersion. Preferentially 0.5 to 10% by weight of MAH polymer is used with respect to the particles containing salt hydrates. After the MAH polymer is added, the whole is stirred for at least half an hour more. During this time the MAH polymer reacts and binds with the reactive groups of the additive chemical and a coating layer is formed around the particle core. Subsequently a cross-linking agent is added to interconnect the MAH polymer chains thus creating a sealing, insoluble coating layer around the particle core. Suitable as cross-lining agents are: 1,3-propane diamine, MXDA, tetraethylene pentamine (TEPA) and polyetheramine T403. Preferentially 50 to 75% by weight of cross-linking agent is used with respect to the amount of MAH polymer. The particle core is sufficiently encapsulated by means of this method. That means that a hydrophobic, inert coating layer around the particle core is formed.

The coating procedure can also be carried out stepwise by, e.g., forming a first SMA layer at the surface of a homogeneous core material according to the invention and then at least cross-linking one pair of the polymer chains in this layer. Subsequently a second SMA layer is added and cross-linked, respectively, etc.

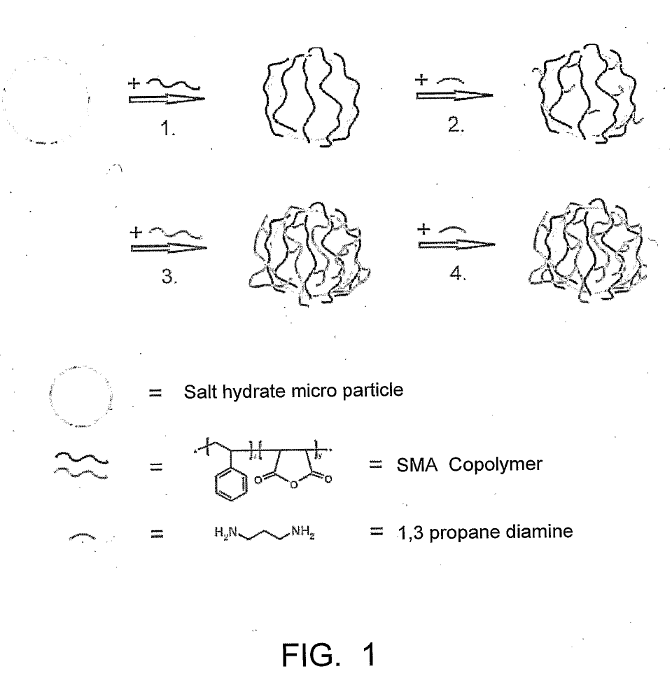

FIG. 1 schematically illustrates a possible reaction mechanism for coating of particle cores that contain salt hydrates according to the invention. In reaction step 1 dissolved reactive polymers are added to a dispersion of the dispersed homogeneous core material. In reaction step 2 the first coating layer is being partly cross-linked using a cross-linking agent, after which the the coated core material is further treated with dissolved reactive polymers (reaction step 3, comparable with reaction step 1) and cross-linking agent, respectively (reaction step 4, comparable with reaction step 2). In this figure the particle core that is to be coated is represented by a circle

Owing to the stable solid core material with the reactive groups present at the surface and the use of polymers with reactive groups for coating, the core according to the invention can be coated using different composition, layers, thicknesses and/or densities, depending on the application of the particle according to the invention.

Furthermore, the invention comprises materials and objects in which particles, according to the present invention, or particle produced using a method according to the present invention, have been applied. It is possible that these materials or objects have construction/building purposes or that they are used for heat storage or heat packs, fertilizers or purification materials.

The present invention will be further explained using the following examples which are not limiting. All percentages are percentages by weight (w/w) of the final product.

### EXAMPLE 1

90% sodium acetate trihydrate

2% sodium pyrophosphate decahydrate

6% monomer blend (5.5% (w/w) acryl amide, 0.5% (w/w) methylene bisacryl amide)

1% triethanol amine

1% ammonium persulfate

The sodium acetate trihydrate was heated to 80° C. until a clear, transparent liquid was formed, in which the nucleating agent sodium pyrophosphate decahydrate and acryl amide, methylene bisacryl amide and triethanol amine were gradually dissolved while stirring. To the homogeneous reaction mixture that was obtained ammonium persulfate was added while stirring to initiate the polymerization. The mixture was continuously stirred until a gel was formed that did not display any flow anymore. This gel hardened overnight at room temperature.

The obtained solid, homogeneous product was milled to yield the core material, having an average diameter of 100 μm and was used for further treatment.

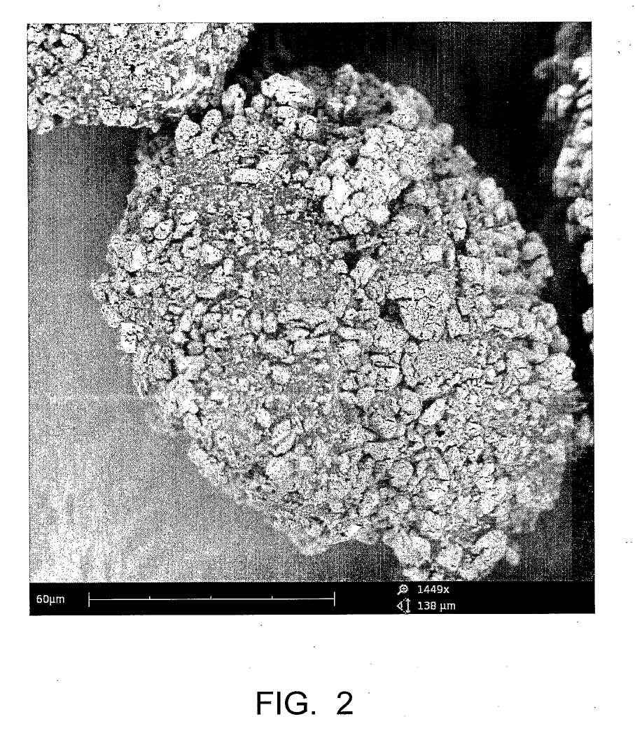

FIG. 2 shows the product that was obtained.

### EXAMPLE 2

92% sodium acetate trihydrate

2% sodium pyrophosphate decahydrate

6% copolymer of sodium acrylate and acryl amide

The sodium acetate trihydrate was heated to 80° C. until a clear, transparent liquid was formed, in which sodium pyrophosphate decahydrate was added. Subsequently the mixture was stirred such, that a homogeneous mixture was obtained, to which the super-absorbing polymer was added while stirring. After hardening overnight, the obtained homogeneous product was milled to yield the core material.

### EXAMPLE 3

90% calcium chloride hexahydrate

2% strontium chloride hexahydrate

6% monomer blend (5.5% (w/w) acryl amide, 0.5% (w/w) methylene bisacryl amide)

1% triethanol amine

1% ammonium persulfate

The calcium chloride hexahydrate was heated to 40° C. until a clear, transparent liquid was formed, in which strontium chloride hexahydrate and acryl amide, methylene bisacryl amide and triethanol amine were gradually added to the molten calcium chloride hexahydrate while stirring and dissolved. To the resulting mixture ammonium persulfate was added while stirring to initiate the polymerization. The mixture was continuously stirred after initiation of the polymerization until a gel was formed that did not display any flow anymore. This gel was crystallized overnight at room temperature, after which the obtained solid material was milled to yield a homogeneous core material.

### EXAMPLE 4

50% sodium acetate trihydrate

50% urea

A mixture of sodium acetate trihydrate and urea was heated to 60° C. until a clear, transparent liquid was formed that crystallized overnight. The obtained solid material was milled to yield a homogeneous core material and used for further treatment.

### EXAMPLE 5

50% sodium acetate trihydrate

50% acetamide

The sodium acetate trihydrate was completely mixed with the acetamide. The thus obtained mixture was then heated to 60° C. until a clear, transparent liquid was formed that crystallized overnight. The obtained solid material was milled to yield a homogeneous core material and used for further treatment.

### EXAMPLE 6

90% sodium sulfate decahydrate (Glauber's salt)

2% sodium tetraborate decahydrate (Borax)

6% monomer blend (5.5% (w/w) acryl amide, 0.5% (w/w) methylene bisacryl amide)

1% triethanol amine

1% ammonium persulfate

The Glauber's salt was heated to 40° C. until a clear, transparent liquid was formed. The salt hydrate melts incongruently, so part of the material precipitated as the anhydrous form. After that, Borax, acrylamide, methylene bisacryl amide and triethanol amine were gradually added to the molten Glauber's salt while stirring. Because not all component dissolve, stirring was performed such, that a homogeneous dispersion or mixture was formed. Subsequently the ammonium persulfate was added to the dispersion or mixture to initiate the polymerization. The dispersion or mixture was continuously stirred after initiation of the polymerization until a gel was formed that did not display any flow anymore. This gel was crystallized overnight at room temperature, after which the obtained solid homogeneous material was milled to yield the core material that was used for further treatment.

### EXAMPLE 7

96% sodium sulfate decahydrate (Glauber's salt)

2% sodium tetraborate decahydrate (Borax)

2% (w/w) copolymer of sodium acrylate and acryl amide

The Glauber's salt was gradually heated to 40° C. The salt hydrate melts incongruently, so part of the material precipitated as the anhydrous form. To the dispersion or mixture the nucleating agent Borax was added while stirring. Like the anhydrous form of Glauber's salt, the Borax did not dissolve. To the dispersion or mixture the super-absorbing polymer was slowly added while stirring vigorously. It was kept stirring until this was not possible anymore, because the reaction mixture became a slurry, too viscous to stir. The slurry hardened entirely at room temperature, after which the obtained solid homogeneous product was milled to yield the core material.

### EXAMPLE 8

### Encapsulation

200 g toluene

50 g core material, obtained according to one of the examples 1 to 7

2 g SMA-2000 (dissolved in 25 g acetone)

2.6 g PEA T403 (dissolved in 10 g toluene)

2 g SMA-3000 (dissolved in 25 g acetone)

1.0 g PEA T403 (dissolved in 10 g toluene)

SMA-2000 (from Sartomer), poly(styrene-co-maleic anhydride) with ratio styrene/maleic anhydride=2/1.

SMA-3000 (from Sartomer), poly(styrene-co-maleic anhydride) with ratio styrene/maleic anhydride=3/1.

PEA T403 (from BASF), polyetheramine T403, CAS No. 39423-51-3,

Mw=403 g/mol, trifunctional amine.

The core material was dispersed in toluene under heavy stirring. After that the SMA-2000 (dissolved in acetone) was added to the dispersion while stirring. After one hour of stirring, 2.6 g of PEA T403 (in 10 g toluene) was added. Subsequently it was stirred for another one hour after which SMA-3000 was added, followed by one hour of stirring. To conclude, the last amount of PEA T403 (in 10 g toluene) was added, followed by stirring the dispersion or mixture for one hour.

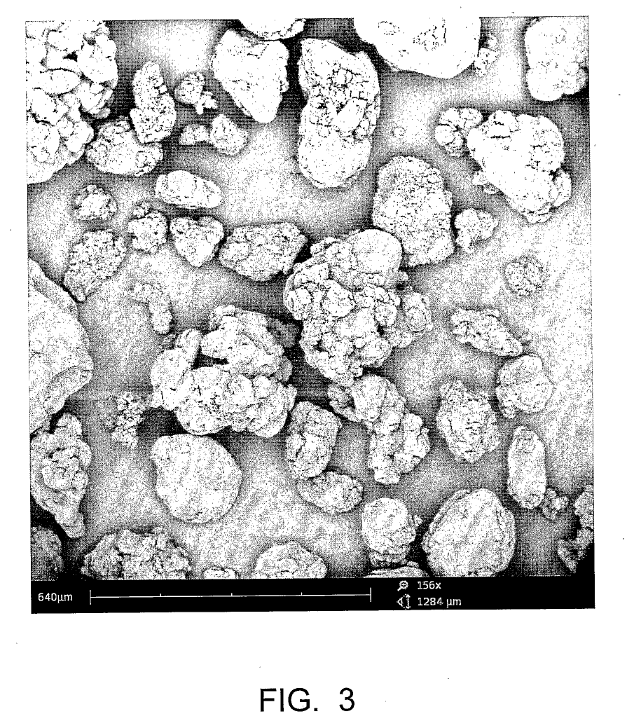

FIG. 3 shows the product that was obtained.

### EXAMPLE 9

### Encapsulation

200 g toluene

50 g core material, obtained according to one of the examples 1 to 6

1 g SMA-2000 (dissolved in 25 g acetone)

0.24 g MXDA (dissolved in 10 g toluene)

1 g SMA-3000 (dissolved in 25 g acetone)

0.1 g MXDA (dissolved in 10 g toluene)

SMA-2000 (from Sartomer), poly(styrene-co-maleic anhydride) with ratio styrene/maleic anhydride=2/1.

SMA-3000 (from Sartomer), poly(styrene-co-maleic anhydride) with ratio styrene/maleic anhydride=3/1.

MXDA: meta-xylylene diamine.

The core material was dispersed in acetone under heavy stirring. To this, the SMA-2000 (dissolved in acetone) was added.

The obtained mixture or dispersion was stirred for one hour, after which 0.24 g MXDA (in 10 g toluene) was added to the mixture or dispersion. After one hour of stirring the SMA-3000 was added to this and it was stirred for one hour. To conclude, the last amount of 0.1 g MXDA (in 0 g toluene) was added to the obtained mixture or dispersion and it was kept stirring for one more hour.

### EXAMPLE 10

### Encapsulation

200 g toluene
100 g monomer blend
   60 g calcium chloride hexahydrate
   30 g magnesium chloride hexahydrate
   5 g acryl amide
   4.5 g hydroxyethyl methacrylate
   0.5 g methylene bisacryl amide
2 g SMA-2000 (dissolved in 25 g acetone)
0.03 g VAZO® 52
2.6 g PEA T403 (dissolved in 10 g toluene)
2 g SMA-3000 (dissolved in 25 g acetone)
1.0 g PEA T403 (dissolved in 10 g toluene)

SMA-2000 (from Sartomer), poly(styrene-co-maleic anhydride) with ratio styrene/maleic anhydride=2/1.

SMA-3000 (from Sartomer), poly(styrene-co-maleic anhydride) with ratio styrene/maleic anhydride=3/1.

PEA T403 (from BASF), polyetheramine T403, CAS No. 39423-51-3,

Mw=403 g/mol, trifunctional amine.

VAZO® 52 (from DuPont): 2,2′-azobis(2,4-dimethyl valeronitrile)

The toluene was heated to 40° C. and, while stirring, the calcium chloride hexahydrate, magnesium chloride hexahydrate, acryl amide, hydroxyethyl methacrylate and methylene bisacryl amide were added. To the thus obtained dispersion the SMA-2000 (dissolved in acetone) was added. After that the obtained dispersion was heated to 60° C. and, while stirring, the VAZO® 52 was added. To the obtained dispersion product, 2.6 g PEA T403 was added while stirring. Subsequently the obtained dispersion or mixture was cooled down to 15° C. After that, the SMA-3000 (dissolved in acetone) and 1.0 g PEA T403 were added while stirring.

For experts, it is evident that the present invention is not limited to the examples that have been discussed above, but that various types and modifications are possible within the range of protection of the invention as defined within the attached conclusions.

For example, it is possible that the core material does not consist of two components, but of three or more components. The extra component might be a thickening agent, or a nucleating agent (seed crystal) and/or an agent to induce freezing point depression and/or a component to form a eutectic mixture and/or act to improve heat transfer. In case this component possesses a reactive group, it might fulfill the function of the second component.

In the previous, amines have been described as an example of cross-linking agents for cross-linking the polymer chains after they have been applied onto the particle core. It has turned out that the amines also have an advantageous effect on the precipitation of coating layer material as well, and, as such, are also capable of acting as additive to promote precipitation. However, these additives have the disadvantage of a possible reaction with the salt hydrate, which is limiting the functionality of the salt hydrate. As an alternative for using amines as additives, it has been found that amino silanes are a good choice as well. The coating process is promoted and the reaction between amino group and salt hydrate is hindered or prevented.

1. Discrete particle, comprising a core including core material, as well as a coating layer surrounding the core, the core material at least containing one salt hydrate;
wherein the core material is a homogeneous composition that includes at least one salt hydrate as well as at least one additive chemical that is chemically bound to the coating layer.

2. Particle according to claim 1, wherein the additive chemical contains at least one chemically reactive group and the coating layer material contains at least one second chemically reactive group, and
wherein the first chemically reactive group and the second chemically reactive group are chemically bound to each other.

3. Particle according to claim 2, wherein the additive chemical contains at least one of the following as a reactive group: an amino group, a hydroxyl group or a carboxyl group.

4. Particle according to claim 1, wherein the core material is a homogeneous composite material.

5. Particle according to claim 1, wherein the core material is a homogeneous eutectic mixture.

6. Particle according to claim 1, wherein at least one additive chemical is chemically bound to at least one salt hydrate.

7. Particle according to claim 6, wherein the additive chemical is chemically bound to both the coating layer and at least one salt hydrate.

8. Particle according to claim 1, wherein the additive chemical is a super-absorbing polymer compound.

9. Particle according to claim 8, wherein the polymer compound is a polymer of one or both acryl amide and sodium acrylate.

10. Particle according to claim 1, wherein the additive chemical is a non-polymeric, organic compound.

11. Particle according to claim 10, wherein the non-polymeric compound is selected from the group consisting of an amine, amide and an amino acid.

12. Particle according to claim 11, wherein the additive chemical is selected from the group consisting of formamide, urea, acetamide, glycine and alanine.

13. Particle according to claim 5, wherein the homogeneous eutectic mixture is based on sodium acetate trihydrate and urea.

14. Particle according to claim 1, wherein the salt hydrate is a heat-accumulating phase change material.

15. Particle according to claim 14, wherein the phase change material is selected from the group consisting of sodium acetate trihydrate, calciumchloride hexahydrate and Glauber's salt.

16. Particle according to claim 1, wherein the coating layer material is a polymer compound with reactive groups, having at least one polar section for binding with the reactive groups of the additive chemical of the core materials and having at least one non-polar section for forming the coating layer of the core material.

17. Particle according to claim 16, wherein the polar section has at least one anhydride compound.

18. Particle according to claim 1, wherein the coating layer comprises at least one polymer compound with maleic anhydride units as reactive group.

19. Particle according to claim 1, wherein the coating layer contains multiple polymer compounds that are interconnected via cross-linking.

20. Particle according to claim 1, wherein the core material is a homogeneous composition based on sodium acetate trihydrate and a polymer of acryl amide and where the core is coated with poly (styrene-co-maleic anhydride).

21. Particle according to claim 1, wherein the core material and/or the coating layer contains at least one additive chemical.

22. Method for preparation of a discrete particle comprising a core including core material as well as a coating layer surrounding the core, wherein the core material includes at least one salt hydrate the method comprising:
joining of a solid, homogeneous core material based on at least one salt hydrate and at least one additive chemical containing at least one chemically reactive group with at least one material forming the coating layer which contains at least one second reactive group; and
allowing a chemical reaction between at least one additive chemical and at least one coating layer material,
wherein a chemical bond is established between the first chemically reactive group of at least a part of the additive chemical and the second chemically reactive group of at least a part of the coating layer material.

23. Method according to claim 22, wherein, in order to join the core material with the material for forming the coating layer, a dispersion of the core material in an organic liquid is treated with a solution of a coating layer forming compound.

24. Method according to claim 22, wherein a polymer compound is used as coating layer material.

25. Method according to claim 24, wherein a cross-linking agent is added after treatment of the homogeneous core material with the polymer material that forms a coating layer containing reactive groups, in order to interconnect the polymer compounds, and
wherein the process is repeated at least once (if required) with the same or another solution of polymer compounds having reactive groups, in order to obtain a more compact, thicker and/or multilayer coating.

26. Method according to claim 22, wherein an additive is used as well.

27. Method according to claim 22, wherein an amino silane compound is used as additive chemical.

28. Method according to claim 22, wherein the method for preparation of the solid, homogeneous core material comprises:
treatment of at least one salt hydrate with monomers that are being used to prepare a polymer additive chemical with at least one chemically reactive group;
polymerization of the monomers within the homogeneous mixture or dispersion, obtained in the preparation step, with the aid of an initiator;
hardening of the homogeneous reaction product, obtained in the polymerization step, to result in a solid, homogeneous core material; and
reducing the size or milling of the obtained solid core material.

29. Method according to claim 22, wherein the method for preparation of the solid, homogenenous core material comprises:
homogeneously mixing or dispersion of at least one salt hydrate with at least one polymer compound containing at least one chemically reactive group;
hardening of the homogeneous reaction product, obtained in the mixing/dispersion step, to result in a solid, homogeneous core material; and
reducing the size or milling of the obtained solid core material.

30. Method according to claim 22, wherein the method for preparation of the solid, homogeneous core material comprises:
homogeneously mixing of at least one salt hydrate with a non-polymeric compound containing at least one reactive group;
heating of the obtained mixture to a liquid, homogeneous mixture;
cooling down or cooling, by which means a solid, homogeneous core material is obtained; and
reducing the size or milling of the obtained solid, homogeneous core material.

31. Method according to claim 22, wherein the method for preparation of the solid, homogeneous core material comprises:
treatment of at least one salt hydrate with monomers in a liquid, which monomers are used to prepare a polymer additive chemical containing at least one reactive group; and
polymerization of the monomers within the homogeneous mixture or dispersion, obtained in the treatment step, with the aid of an initiator.

32. Method according to claim 28, wherein salt hydrates are treated in the molten state with at least one additive chemical or monomers.

33. Method according to claim 28, wherein an additive is used as well.

34. Discrete particle, prepared using a method according to claim 22.

35. A material that comprises a particle according to claim 1.

36. (canceled)
